(19) United States
(12) Patent Application Publication
(10) Pub. No.: US 2025/0176484 A1
(43) Pub. Date: Jun. 5, 2025

(54) OUTPUT SIGNAL POWER MANAGEMENT FOR IRRIGATION CONTROLLERS

(71) Applicant: Rain Bird Corporation, Azusa, CA (US)

(72) Inventors: Harvey J. Nickerson, El Cajon, CA (US); Gustavo Corona, Chula Vista, CA (US)

(21) Appl. No.: 18/966,069

(22) Filed: Dec. 2, 2024

Related U.S. Application Data
(60) Provisional application No. 63/605,128, filed on Dec. 1, 2023.

(51) Int. Cl. A01G 25/16; G05D 7/06; H01F 7/06

(52) U.S. Cl. CPC A01G 25/16; G05D 7/0652; H01F 7/064

(57) ABSTRACT

In some embodiments, apparatuses and methods are provided herein useful to manage a power output of an irrigation controller. In some embodiments, irrigation controller is provided that includes an AC to DC converter configured to convert an input AC signal into a DC voltage; a control circuit to generate a PWM signal; a signal generator to generate, based on the DC voltage and the PWM signal, an output signal. In some embodiments, the output signal is a multi-stage output signal having a first stage sufficient to cause actuation of a non-latching solenoid-actuated valve to an open position and a second stage to maintain the open position. A plurality of switches switch the output signal to station output connectors which are to be connected to a respective non-latching solenoid actuated valve.

### CROSS-REFERENCE TO RELATED APPLICATIONS

This application claims the benefit of U.S. Provisional Application No. 63/605,128 filed Dec. 1, 2023, entitled OUTPUT SIGNAL POWER MANAGEMENT FOR IRRIGATION CONTROLLERS (Attorney Docket No. 8473-158529-US), which is incorporated herein by reference in its entirety.

### TECHNICAL FIELD

This invention relates generally to irrigation controllers, and more particularly to the power output by irrigation controllers.

### BACKGROUND

Irrigation systems usually include a number of valves electronically controlled by an irrigation controller, each valve controlling the flow of water to one or more sprinklers. In some irrigation systems, there are tens of valves to be controlled by the irrigation controller. A typical non-latching solenoid-actuated valve requires continuous AC power from the irrigation controller to open the valve and maintain the valve in an open state for the duration of watering. The available power from the irrigation controller and/or water pressure can limit how many valves can be controlled by the irrigation controller at the same time.

### BRIEF DESCRIPTION OF DRAWINGS

Disclosed herein are embodiments of systems, apparatuses and methods pertaining to the control of power output from an irrigation controller. This description includes drawings, wherein:

FIG. 1 is an example central irrigation control system in which irrigation controllers control the operation of irrigation valves to control irrigation in accordance with some embodiments.

FIG. 2 is an irrigation control unit for providing power to irrigation valves in accordance with some embodiments.

FIG. 3 is an irrigation control unit for managing a power output to irrigation valves including a transformer to provide a multiple signal outputs in accordance with some embodiments.

FIG. 4 is an irrigation control unit for managing a power output to irrigation valves including a signal generator to a multiple signal outputs in accordance with some embodiments.

FIG. 5 is an irrigation control unit for managing a power output to irrigation valves including a signal generator to a multiple signal outputs in accordance with some embodiments.

FIG. 6 is an example user interface to adjust parameters of an output signal of an irrigation control unit in accordance with some embodiments.

FIG. 7 is a flow diagram of a method of managing a power output of an irrigation control unit in accordance with some embodiments.

FIG. 8 is an example signal generator of an irrigation controller using an H-bridge circuit in accordance with some embodiments.

FIG. 9 is an example pulse width modulated (PWM) signal and corresponding filtered output signal in accordance with some embodiments.

And FIGS. 10A-10B illustrate example output signals in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to controlling the output signal of an irrigation controller. In some embodiments, a power output of an irrigation controller is controlled to change (e.g., increase) the number of valves that can be activated by an irrigation controller, such as a satellite irrigation controller of a central irrigation control system or standalone irrigation controller.

In some embodiments, an irrigation controller is provided including: an AC to DC converter configured to convert an input AC signal into a DC voltage; a control circuit coupled to the AC to DC converter and configured to generate a PWM signal. The controller also includes a signal generator coupled to the AC to DC converter and to the control circuit, wherein the signal generator is configured to generate, based on the DC voltage and the PWM signal, an output signal. In some embodiments, the output signal comprises a multi-stage output signal comprising: a first stage of an alternating waveform having a first power level sufficient to cause actuation of a non-latching solenoid-actuated valve from a closed position to an open position; and a second stage of the alternating waveform following the first stage and having a second power level that is lower than the first power level and is sufficient to maintain the non-latching solenoid-actuated valve in the open position. And the irrigation controller includes a plurality of switches each coupled to the signal generator, wherein the control circuit is configured to selectively control operation of the plurality of switches to switch the output signal to one or more of a plurality of station output connectors, each of which is configured to be connected to a respective non-latching solenoid actuated valve.

In some embodiments, a method of managing power in an irrigation system comprises: converting, by an alternating current (AC) to direct current (DC) converter of an irrigation controller, an input AC signal into a direct current (DC) voltage; generating, by a control circuit of the irrigation controller, a pulse-width modulation (PWM) signal; generating, by a signal generator of the irrigation controller and based on the DC voltage and the PWM signal, an output signal, wherein the output signal comprises a multi-stage output signal comprising: a first stage of an alternating waveform having a first power level sufficient to cause actuation of a non-latching solenoid-actuated valve from a closed position to an open position; and a second stage of the alternating waveform following the first stage and having a second power level that is lower than the first power level and is sufficient to maintain the non-latching solenoid-actuated valve in the open position; and switching the output signal to one or more of a plurality of station output connectors, each of which is configured to be connected to a respective non-latching solenoid actuated valve.

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the invention. Thus, appearances of the phrases “in one embodiment,” “in an embodiment,” “in some embodiments”, “in some implementations”, and similar language throughout this specification may, but do not necessarily, all refer to the same embodiment.

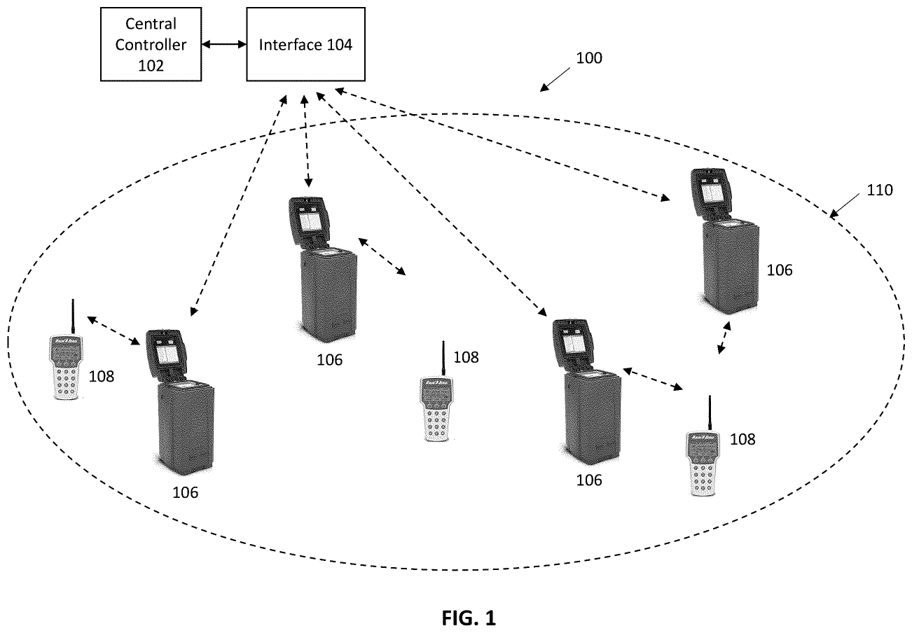

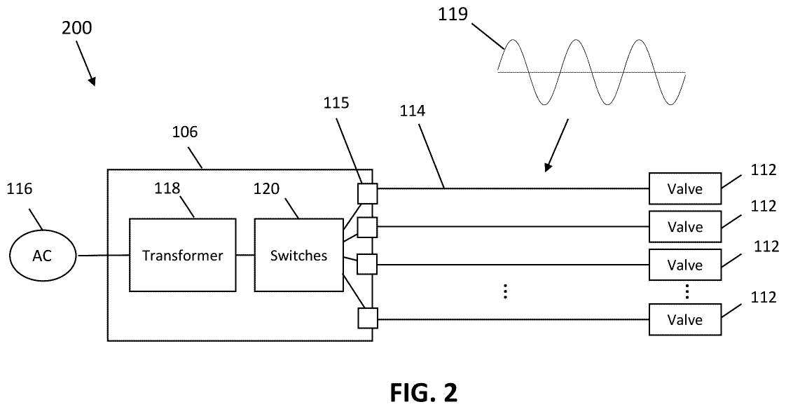

Referring to FIG. 1, a central irrigation control system 100 in accordance with some embodiments is shown that includes a central controller 102, one or more interface units 104, and irrigation controllers 106. The irrigation controllers 106 (which in some embodiments are referred to as satellite irrigation controllers) are each coupled to and control irrigation valves (such as the valves 112 shown in FIG. 2) or stations that control water flow to one or more sprinklers located at an irrigation site 110.

In some embodiments, the central controller 102 is a computer or server having irrigation control software that allows users to create watering schedules to coordinate watering at an irrigation site 110. In some embodiments, the central controller 102 is wirelessly connected to the interface units 104 via any suitable wired and/or wireless communication network or link. In some embodiments, the central controller 102 includes a user interface such as a computer interface which a user may interact with in order to create and/or modify a watering schedule.

In some embodiments, the interface unit 104 receives schedules and/or commands from the central controller 102 and communicates those schedules and/or commands to the irrigation controllers 106. In some embodiments, the communication between the interface unit 104 and the irrigation controllers 106 can be by any suitable wired and/or wireless communication network or link. In some embodiments, the central controller 102 and/or the interface unit 104 are at or proximate to the irrigation site 110, while in some aspects, the central controller 102 and/or the interface unit 104 are remote from to the irrigation site 110.

The satellite irrigation controllers 106 can store and execute schedules, or can receive signals based on schedules stored at and executed by the central controller 102. Users at the site 110 can use a handheld remote 108 to directly communicate with a given irrigation controller 106 and/or may operate a user interface of the irrigation controller 106 itself if present.

In some embodiments, the central irrigation control system 100 controls a number of valves. For example, if the irrigation site 110 is a golf course, for example, there may be tens of irrigation controllers 106 spread throughout the course, each controlling tens of irrigation valves. In another example, if the irrigation site 110 is a residential property, for example, there may be only be one irrigation controller 106 controlling a smaller number of valves. It is generally contemplated that any suitable irrigation site 110 with any number and/or configuration of irrigation controllers 106 may be used.

It is noted that while FIG. 1 illustrates satellite irrigation controllers 106 of a central irrigation control system 100, it is understood that some of the described embodiments are also applicable to irrigation controllers 106 generally, whether part of a central irrigation control system 100 or a standalone irrigation controller 106 such as a residential irrigation controller 106.

Referring next to FIG. 2, an irrigation system 200 shown including an irrigation controller 106 which controls watering by selectively opening valves 112 in the field that allows water to pass therethrough to sprinklers. As is common, each controlled valve 112 can be referred to as a station. The satellite 106 has multiple station output connectors 115 (e.g., terminal block connections), each having a respective wire 114 that extends from the station output connector 115 of the controller 106 to a valve 112. To open a given valve 112, the controller 106 outputs an AC power signal (which may also be generically referred to herein as an output signal 119) on the wire to the valve 112. With power applied, the valve 112 opens. Since the valves 112 in some embodiments are non-latching valves, continuous power must be applied to keep the valve 112 open. If the output signal 119 is turned off, then the valve 112 will close. Typically, the controller 106 receives an input voltage 116 (e.g., 120 VAC or 240 VAC) at 50 or 60 Hz. In some embodiments, the controller 106 includes a transformer 118 that steps the input voltage signal 116 to a lower voltage output signal 119 (e.g., 26.5 VAC rms) which is selectively switched by switches 120 to the selected output connector 115.

In some embodiments, power management can be used to increase the number of valves (stations) supported by the controller. Available water pressure can limit the number of valves that can be operated at one time. And in some cases, the available voltage limits the number of valves that can be activated by the controller 106 at the same time. An example controller 106 described above can typically activate sixteen valves at the same time. However, it may be desired to support and activate more valves, e.g., 32 or more valves at the same time. In some embodiments, this can be done by increasing the input power, but this is not desirable since the input power may be fixed and the increased power may require running a higher gauge wire to the irrigation controller 106 increasing installation costs. Thus, according to some embodiments, the output signal applied to the lines or wires 114 is controlled to provide an output signal with a high initial power to open the valve, then once the valve is open, the output signal is switched to have a lower power to hold the valve open. Several exemplary approaches are described to accomplish this.

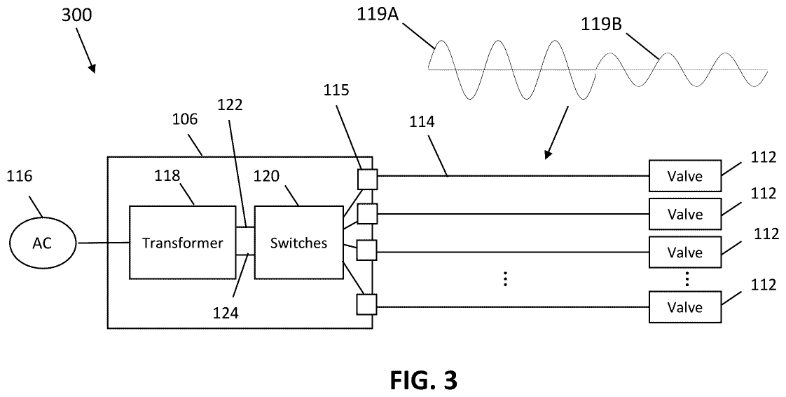

Referring next to FIG. 3, an irrigation system 300 is shown that utilizes a first general approach of power management which involves switching between an initial higher power output AC signal 119A to open the valve 112 and one or more lower power holding output AC signals 119B to maintain the valve 112 in the open position. It is recognized that the valves 112 generally require a relatively large initial output signal 119A (relative to the output signal 119B required to keep the valve 112 open) to overcome inertia and open the valve 112. Once the valve 112 is open, a lower output signal 119B, or “holding voltage”, may be applied to keep the valve 112 in an open state after being actuated. Generally, the system 300 includes the same components as the system 200, however, with variation to the configuration of and/or components of the irrigation controller 106. While the embodiment shown in FIG. 3 depicts the components of the irrigation controller 106 in one configuration, it is generally understood that any alternate connections between components may be made, any additional components may be included, and/or any alternate configuration of components may be used in accordance with some embodiments.

In some embodiments, the initial output signal 119A is configured to provide a valve 112 at least the minimum amount of power and/or actuation power level required to open the valve 112. In some aspects, by providing a valve 112 with the minimum amount of power required to open the valve 112, the irrigation controller 106 is able to conserve and/or use less power. If the initial output signal 119A corresponds with the minimum amount of power required to open a valve 112 and the irrigation controller 106 receives the same input AC signal 116 as in non-power managements systems, the irrigation controller 106 may be able to actuate additional valves 112. Any suitable value of the initial output signal 119A may be output dependent on the required minimum power by the valve 112. For example, the initial output signal 119A may be a 26.5 VAC rms signal which provides about 400 mA of current to open the valve 112, however, any alternate suitable value may be used.

In some embodiments, after the initial output signal 119A has been applied to a valve 112, the irrigation controller 106 may then apply the lower output signal 119B to keep the respective valve 112 open. In some embodiments, a time delay may be used to account for the time required for the valve 112 to be opened, and after the time delay a lower output signal 119B may be applied and provide less current to the valve 112, but enough to hold open the valve 112. Generally, the lower output signal 119B and associated current is sufficient to prevent the valve 112 from closing. As described above with regard to the initial output signal 119A, the valves 112 may additionally have a minimum amount of power and/or maintenance power level required to keep a valve 112 in an open state after it has been actuated. By utilizing the minimum amount of power, the irrigation controller 106 may be able to actuate and/or keep open more valves 112 than when a greater lower output signal 119B is used. In one example, the lower output signal 119B applied is an 18 VAC rms signal, however, it is generally understood that any alternate suitable value of the lower output AC signal 119B may be used. In some embodiments, the time delay described is variable, however, it preferably lasts the first four to ten (e.g., five) AC cycles of the initial output AC signal 119A.

In some embodiments, the switches 120 are configured to simultaneously output the output signal 119 (i.e., the initial output signal 119A) to actuate a first subset of the valves and output a maintenance power level of the output signal 119 (i.e., the lower output signal 119B) to maintain a second subset of the valves in the open state. In some forms, a first switch 120 may be configured to output a first power level (e.g., the initial output signal 119A) of the output signal 119 to at least a first valve 112 and a second valve, and a second switch 120 may be configured to output a second power level (e.g., the lower output signal 119B) of the output signal 119 to at least the first valve 112 and the second valve 112. In other words, one switch 120 may be configured to output the initial output signal 119A to multiple valves 112, and an additional switch 120 may be configured to output the lower output signal 119B to the same valves 112.

As shown in FIG. 3, in some embodiments, to provide multiple output signals 119 to the station output connectors 115 and/or valves 112, the irrigation controller 106 switches between multiple AC sources (e.g., to provide the initial output signal 119A and the lower output signal 119B) via a plurality of taps 122, 124. To provide the multiple output signals 119, in some embodiments, there are multiple “taps” 122, 124 coupling the switches 120 to the transformer 118, each at different output signal 119 levels. The taps 122, 124 are generally configured to allow a smaller amount of conduction to be output from a larger conduction source. In other words, if a transformer 118 outputs an output signal 119 greater than what is required to open a valve 112, a first tap 122 may divert an initial output signal 119A configured to supply a valve 112 with a minimum power level to be opened, and a second tap 124 may divert a lower output signal 119B configured to supply a valve 112 with a minimum power level to remain open. The taps 122, 124 may be configured to output any suitable value of the output signal 119. For example, one tap 122 or output of the transformer 118 is at 26.5 VAC and a second tap 124 or output of the transformer 118 is at 18 VAC rms, essentially allowing for switching between different output signals 119. Any number of taps 122, 124 may be used depending on how many output signals 119 are required to actuate and keep open the valves 112 coupled to the irrigation controller 106. In some embodiments, more than two output signals 119 are needed. While 26.5 VAC rms and 18 VAC rms are sufficient for some installations, other installations may need more than 18 VAC rms to hold a valve 112 open. By using multiple taps 122, 124, different output signals 119 may be provided and selected from (e.g., 26.5, 24, 20, 20, 18, 16 VAC and so on). Therefore, in some embodiments, there may be n output signals 119, n being a positive integer number, to provide an output signal 119 having any one of n voltage levels to the valves 112. Generally, the switches 120 are configured to switch between the different taps 122, 124. In some aspects, the taps 122, 124 may include any suitable combination of power distribution taps, line taps, tap conductors, etc.

In some embodiments, rather than switching between different taps 122, 124 of the transformer 118, more than one transformer 118 may be used. Some embodiments may include, for example, two transformers 118, each outputting a different output signal 119 (e.g., the initial output signal 119A and the lower output signal 119B), and the switches 120 may be configured to switch between the different transformers 118. Any suitable number of transformers 118 may be used to generate any suitable number of output signal 119. In some embodiments, the irrigation controller 106 may include any number and/or configuration of transformers 118 which may and/or may not include taps 122, 124. For example, an irrigation controller 106 may include two transformers 118 each with two taps 122, 124.

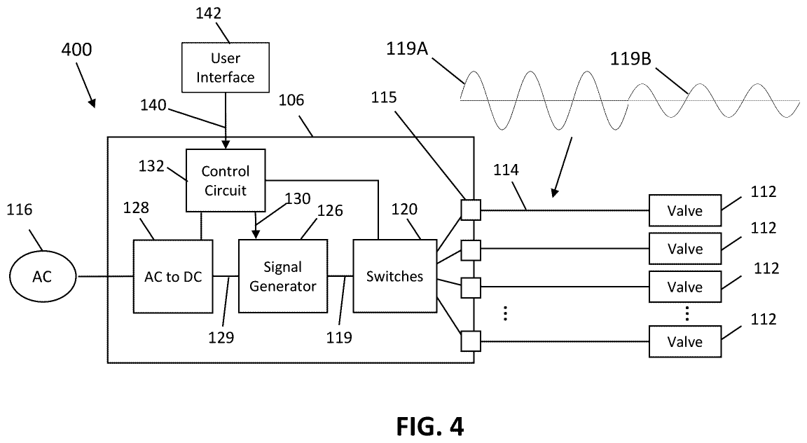

Referring next to FIG. 4, a system 400 utilizes a second approach of power management involving using a signal generator 126 to generate an output signal 119 (e.g., a voltage modulated output AC signal) that changes voltage levels and thus changes power levels. For example, in some embodiments, the irrigation controller 106 provides an output signal 119 that is a multi-stage output signal comprising: a first stage of an alternating waveform (e.g., a first sinusoidal AC voltage signal having a first amplitude) having a first power level sufficient to cause actuation of a non-latching solenoid-actuated valve from a closed position to an open position; and a second stage of the alternating waveform (e.g., a second sinusoidal AC voltage signal having a second amplitude) following the first stage and having a second power level that is lower than the first power level and is sufficient to maintain the non-latching solenoid-actuated valve in the open position.

In the described embodiment, the irrigation controller 106 includes an AC to DC converter 128, the signal generator 126 (e.g., an AC signal generator), a control circuit 132, and the switches 120. Generally, the system 400 includes the same components as the systems 200, 300, however, with variation to the configuration of and/or components of the irrigation controller 106. While the embodiment shown in FIG. 4 depicts the components of the irrigation controller 106 in one configuration, it is generally understood that any alternate connections between components may be made, any additional components may be included, and/or any alternate configuration of components may be used in accordance with some embodiments.

In some embodiments, the AC to DC converter 128 is coupled to and configured to receive the input AC signal 116. In some aspects, the input AC signal 116 (e.g., 50 or 60 Hz) is converted into a DC voltage 129 by the AC to DC converter 128. Further, the AC to DC converter 128 also provides a suitable DC voltage for the control circuit 132 to use for operational power (e.g., the converter 128 also provides a 5 VDC signal). Such AC to DC voltage converters 128 and/or alternate suitable switching power supplies are commercially available and known in the art. In some embodiments, such as for irrigation controllers 106 configured to be used indoors, the AC to DC voltage converter 128 may be a “wall-wart” style supply that plugs into a power outlet. In some embodiments, such as for irrigation controllers 106 configured to be used outdoors, the AC to DC voltage converter 128 may be on-board/integrated with the irrigation controller 106 (as shown in FIG. 4). In some embodiments, the AC to DC converter 128 can be an off-the-shelf AC to DC power supply (such as, a universal input 100 VAC to 240 VAC 50 Hz/60 Hz with 48 VDC output).

In some embodiments, the signal generator 126 is coupled to the AC to DC converter 128, the control circuit 132, and the switches 120. Generally, the signal generator 126 is configured to generate the output signal 119 (e.g., an output AC voltage signal) similar to that described above based on the DC voltage 129 output by the AC to DC converter 128 and control signaling from the control circuit 132 to output the output signal 119 to the switches 120. The signal generator 126 may be configured to output a fixed and/or variable output signal 119. In some embodiments, the signal generator 126 is configured to generate and output a multi-stage output signal 119 having a first stage of an alternating waveform (e.g., output signal 119A) having a first power level sufficient to cause actuation of a non-latching solenoid-actuated valve from a closed position to an open position. And, in some embodiments, the multi-stage output signal 119 has a second stage of the alternating waveform (e.g., the lower output signal 119B) following the first stage and having a second power level that is lower than the first power level and is sufficient to maintain the non-latching solenoid-actuated valve in the open position. In some embodiments, the signal generator 126 is configured to receive any number of additional signals (e.g., control signals from the control circuit 132) in order to generate the output signal 119 and/or vary the power, voltage, and/or timing of the output signal 119. Any signal generator 126 known in the art that is configured to utilize the DC voltage 129 may be used. For example, the signal generator 126 may further include any suitable components such as H-bridges, rectifiers, transistors, etc.

In some embodiments, the control circuit 132 is coupled to the signal generator 126, and, in some aspects, is further coupled to the AC to DC converter 128. In the accordance with the system 400, the control circuit 132 is generally configured to at least generate and output a pulse-width modulation (PWM) signal 130 to the signal generator 126 to control generation of the output signal 119. In some forms, the control circuit 132 is configured to control, via the PWM signal 130, a power level of the output signal 119 (e.g., by controlling the time that the DC voltage is switched by an H-bridge of the signal generator to control the amplitude of the waveform) to actuate at least one valve 112 and to maintain the at least one valve 112 in an open state after actuation. In other words, the output signal 119 may initially have an actuation power level to actuate the valves 112 (generically, a first power level) and then switch to a maintenance power level to maintain the valves 112 in the open state after actuation of the valves 112 (generically, a second power level). Generally, the actuation power level is greater than the maintenance power level. Generally, the valves 112 are configured to open when at least the actuation power level is received and are configured to remain in the open state when at least the maintenance power level is received. In some embodiments, the actuation power level corresponds with the power level of the initial output signal 119A, and the maintenance power level corresponds with the power level of the lower output signal 119B. In some embodiments, the control circuit 132 may be further cooperated with the central controller 102 and/or the interface units 104 and configured to actuate the switches 120 in accordance with a watering schedule of the irrigation controller 106 and/or associated valves 112.

In some embodiments, the control circuit 132 is a programmable processor (e.g., a microprocessor or a microcontroller). And in some embodiments, the control circuit 220 can comprise a fixed-purpose, hard-wired platform or can comprise a partially or wholly programmable platform, such as a microcontroller, an application specification integrated circuit, a field programmable gate array, and so on. These architectural options are well known and understood in the art and require no further description. The control circuit 132 may be configured (for example, by using corresponding programming stored in a memory as will be well understood by those skilled in the art) to conduct one or more of the steps, actions, and/or functions described herein.

In some embodiments, the signal generator 126 applies the DC voltage 129 to an H-bridge circuit and the PWM signal 130 causes the transistors of the H-bridge to switch in a manner that creates the desired output signal 119 having a modulated voltage level. In this way, the output signal 119 can initially be at a high power level for valve 112 activation (open/close) (e.g., the initial output signal 119A at, for example, 26.5 VAC rms), then after a time delay (e.g., 5 AC cycles), switch to a lower power level (e.g., the lower output signal 119B at, for example, 18 VAC rms) to maintain the valve in the open position. In some embodiments, the PWM signal 130 can modulate the voltage of the output signal 119 on a cycle-by-cycle basis. In some embodiments, the signal generator 126 generates multiple output signals 119 from a single input power supply. In some embodiments, this power control methodology saves power and can allow for the actuation of more valves at the same time. It is noted that an example version requires that the AC to DC converter 128 provides a peak DC voltage of about 40 volts in order to generate an AC waveform that is 26.5 VAC rms. It is generally understood that the values provided herein are for example only, and that any alternate suitable values may be utilized.

An advantage to some embodiments of this approach is that the voltage of the output signal 119 (and thus, the power) may be closely controlled and configurable to be at the specified level regardless of the level of or variances in the input AC signal 116. In some embodiments, full control of the waveforms is provided by use of the control circuit 132 and the PWM signal 130. For example, in some embodiments, the characteristics of one or both of the initial output signal 119A and the lower output signal 119B can be configured to fit the needs of the system 400. For example, in some embodiments, by changing the PWM signal 130 through firmware settings, one or both of the period and amplitude of the output AC signals 119 can be set or changed. In some embodiments, the parameters to generate the PWM signal 130 to provide a given output signal are retrieved from memory internal to or coupled to the control circuit 132, the memory storing different sets of parameters to PWM signaling to create any of the output signals described and variations thereof.

It is noted that further details relating to generating a new AC waveform from a received AC waveform by using a PWM signal applied to a DC voltage are described in the following patent document and such techniques may be applied for the purposes herein. The following document is incorporated herein by reference: U.S. Pat. No. 11,357,181, granted Jun. 14, 2022, titled DATA MODULATED SIGNAL GENERATION IN A MULTI-WIRE IRRIGATION CONTROL SYSTEM (Docket No. 8473-150383-US).

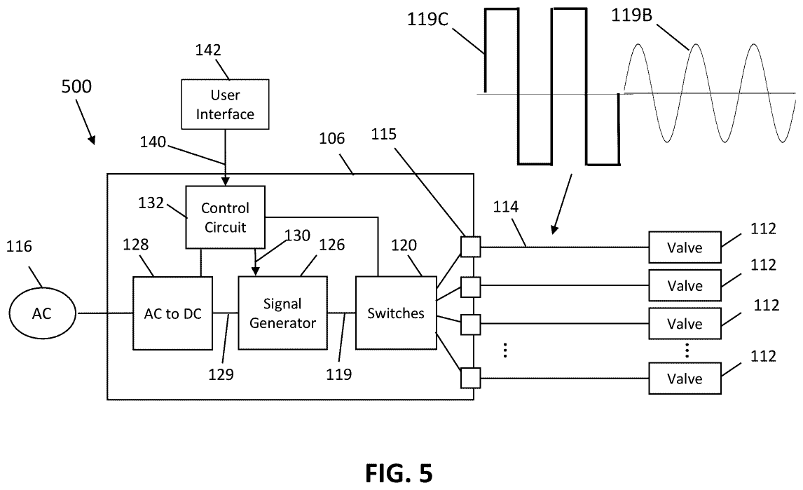

Referring next to FIG. 5, a system 500 of a third approach of power management involves using an alternating DC pulse signal 119C (generically referred to as an alternating square wave voltage signal) to open a valve 112, then switching to the lower power output signal 119B described above to keep the valve 112 open. For example, in some embodiments, the irrigation controller 106 provides an output signal 119 that is a multi-stage output signal comprising: a first stage of an alternating waveform (e.g., an alternating square wave voltage signal such as the alternating DC pulse signal 119C) having a first power level sufficient to cause actuation of a non-latching solenoid-actuated valve from a closed position to an open position; and a second stage of the alternating waveform (e.g., a sinusoidal AC voltage signal 119B) following the first stage and having a second power level that is lower than the first power level and is sufficient to maintain the non-latching solenoid-actuated valve in the open position.

Generally, the system 500 includes the same components as the systems 200, 300, 400, however, with variation to the configuration of and/or components of the irrigation controller 106. While the embodiment shown in FIG. 5 depicts the components of the irrigation controller 106 in one configuration, it is generally understood that any alternate connections between components may be made, any additional components may be included, and/or any alternate configuration of components may be used in accordance with some embodiments.

In the embodiments of FIG. 5, the signal generator 126 uses the DC voltage 129 from the AC to DC converter 128 and the PWM signal 130 to output the alternating DC pulse signal 119C to open the valve 112, then switches to the lower voltage AC waveform (e.g., 12 VAC rms) to hold the valve 112 open. In this example, the lower AC waveform is about 12 VAC rms but could also be 18 VAC rms as shown in FIG. 4. In one embodiment, the alternating DC pulses of the alternating DC pulse signal 119C alternate between having an amplitude of +24 volts to −24 volts. The characteristics of the PWM signal 130 control the switching of the H-bridge to produce the alternating DC pulse signal 119C, and then the characteristics of the PWM signal are changed to generate the lower power output AC signal 119B.

In some forms, utilizing the alternating DC pulse signal 119C instead of an initial output AC signal 119A as shown in FIG. 4 decreases the minimum DC voltage required to be output by the AC to DC converter 128 in order to open the valves 112. For example, in some embodiments, in order for the signal generator 126 of FIG. 4 to produce an output AC voltage signal at 26.5 VAC rms, the AC to DC converter 128 of FIG. 4 needs to output a starting DC voltage 129 of at least about 40 VDC. However, in the embodiments shown in FIG. 5 which provides an initial alternating DC pulse signal 119C, the AC to DC converter 128 of FIG. 5 need only provide an output DC voltage 129 of about 26.5 VDC (e.g., in some embodiments, an AC to DC converter 128 providing a DC voltage 129 of about 24 VDC will actuate most common irrigation valves). Thus, the power requirements of the AC to DC converter 128 are reduced leading to lower power usage by the irrigation controller 106. Further, since the AC to DC converter 128 providing a DC voltage 129 of about 24 VDC is sufficient to generate the second stage holding signal 119B (e.g., at 12 or 18 VAC rms) to maintain the valve 112 in the open position.

In some embodiments, user input 140 received via a user interface 142 may be provided to one or both of the embodiments of FIGS. 4 and 5 to cause the control circuit 132 and the signal generator 126 to adjust or customize the characteristics of one or both portions of the output signal 119. For example, Some installations may require more or less than 12 or 18 VAC rms depending on the number of valves 112, type of valves 112, valve manufacturer, valve specifications, and/or distance of the valves 112 from the irrigation controller 106, etc. For example, valves 112 located farther away from the irrigation controller 106 may need a higher initial output signal 119A and/or lower output signal 119B than valves 112 located closer to the irrigation controller 106. In some embodiments, these adjustments can be made by changing the PWM signal to result in the desired output signal characteristics.

In some embodiments, a user input 140 may be provided to the control circuit 132 to cause the control circuit 132 to vary the PWM signal 130 in accordance with the user input 140. The user may be provided adjustment options via a user interface 142 for user selection. A user interface 142 can be provided at the central controller 102, at a user interface of the irrigation controller 106, at a handheld remote 108 and/or any other device in communication with the irrigation controller 106, such as a remote computer or mobile device (such as a mobile telephone or mobile tablet) operating an interface provided by the central controller 102 and/or by an irrigation control application being executed on the remote computer or the mobile device. In some embodiments, the user interface 142 provides user selectable options to define, set or adjust a parameter of the output signal 119.

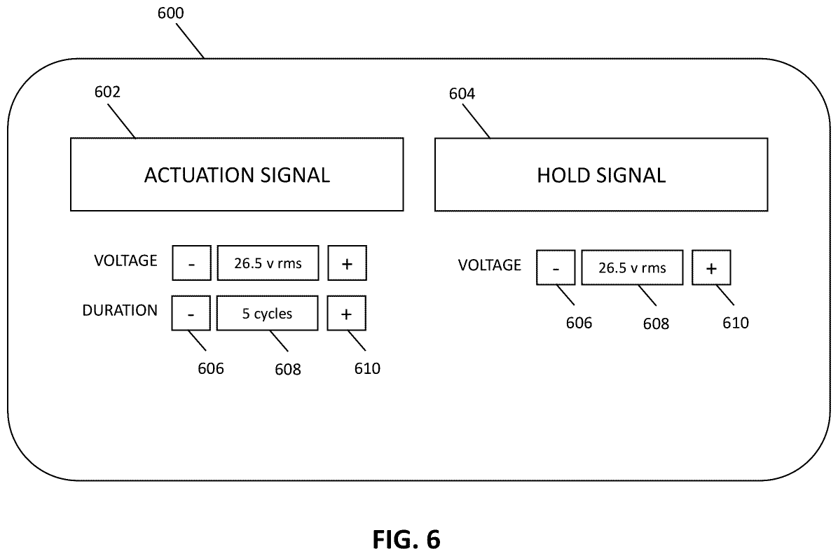

Referring next to FIG. 6, an example user interface 600 is provided in accordance with some embodiments to allow a user to set or adjust one or more parameters of the output signal 119. The user interface 600 is provided via an interactive display which may allow the user to touch or activate certain visual features of the user interface 600. In some embodiments, the visual features may be activated using separate buttons or knobs to select and adjust the parameters. In this example user interface 600, the user may adjust the actuation signal characteristics 602 (e.g., output signal 119A and/or 119C), such as the voltage (e.g., VAC rms or amplitude of an alternating AC or DC waveform) and/or the duration of the actuation signal (e.g., the number of cycles), and/or may adjust the hold signal characteristics 604 (e.g., output signal 119B), such as the voltage. In the illustrated embodiment, the user can view the current parameter value 608 and select to increase (activating the appropriate “+” symbol 610) or decrease (activating the appropriate “−” symbol 606) of the various parameters. In some embodiments, each increase or decrease corresponds to stored corresponding PWM signal characteristics at the control circuit 132. The resulting selection is communicated as the input 140 to the control circuit 132. It is understood that this user interface may be implemented in many ways, this being one non-limiting example.

Generally, this application describes power management approaches to reduce the power usage by an irrigation controller, and that can be useful to controlling a higher number of valves that can be controlled without these power management approaches. In some embodiments, an irrigation controller is provided that includes: an AC to DC converter configured to convert an input AC signal into a DC voltage (e.g., DC voltage 129); a control circuit (e.g., control circuit 132) coupled to the AC to DC converter and configured to generate a PWM signal (e.g., PWM signal 130). The controller also includes a signal generator (e.g., signal generator 126) coupled to the AC to DC converter and to the control circuit, wherein the signal generator is configured to generate, based on the DC voltage and the PWM signal, an output signal (e.g., output signal 119). In some embodiments, the output signal comprises a multi-stage output signal comprising: a first stage of an alternating waveform (e.g., output signals 119A and 119C) having a first power level sufficient to cause actuation of a non-latching solenoid-actuated valve from a closed position to an open position; and a second stage of the alternating waveform (e.g., output signal 119B) following the first stage and having a second power level that is lower than the first power level and is sufficient to maintain the non-latching solenoid-actuated valve in the open position. And the irrigation controller includes a plurality of switches (e.g., switches 120) each coupled to the signal generator, wherein the control circuit is configured to selectively control operation of the plurality of switches to switch the output signal to one or more of a plurality of station output connectors (e.g., station output connectors 115), each of which is configured to be connected to a respective non-latching solenoid actuated valve (e.g., valve 112).

In some embodiments, the PWM signal causes the signal generator to generate the output signal such that the first stage of the alternating waveform comprises a first sinusoidal AC voltage signal (e.g., output signal 119A) having a first amplitude and the second stage of the alternating waveform comprises a second sinusoidal AC voltage signal (e.g., output signal 119B) having a second amplitude, the second amplitude lower than the first amplitude. In some embodiments, the PWM signal causes the signal generator to generate the output signal such that the first stage of the alternating waveform comprises a first alternating square wave voltage signal (e.g., output signal 119C) having the first amplitude and the second stage of the alternating waveform comprises a second sinusoidal AC voltage signal (e.g., output signal 119B) having a second amplitude, the second amplitude lower than the first amplitude. In some embodiments, each station output connector is coupled by a wireline (e.g., wire 114) to the respective non-latching solenoid-actuated valve. In some embodiments, the control circuit is further configured to modify, through variation of the PWM signal, an amplitude of the output signal.

In some embodiments, the AC to DC converter is directly coupled to the input AC signal without first passing through an AC transformer. In some embodiments, a time duration of the first stage of the alternating waveform corresponds to 4 to 10 cycles of the output power signal, e.g., 5 cycles. In some embodiments, a time duration of the second stage of the alternating waveform corresponds to a remainder of a scheduled irrigation run time. In some embodiments (such as embodiments providing a sinusoidal AC voltage signal such as output signal 119A), the AC to DC converter outputs a DC voltage (e.g., DC voltage 129) of between about 34 and 48 volts, preferably between about 37 and 48 volts. In some embodiments (such as embodiments providing a square wave voltage signal such as output signal 119C), the AC to DC converter outputs a DC voltage of between about 24 and 28 volts, e.g., 26.5 volts. In some embodiments, the Vrms value of the output signal 119A is between about 24 and 28 volts, e.g., 26.5 volts rms. In some embodiments, the Vrms value of the output signal 119B is between about 11 and 20 volts rms, e.g., 16-18 volts rms In some embodiments, the control circuit is configured to change the PWM signal for the signal generator to transition from the first stage of the alternating waveform to the second stage of the alternating waveform. In some embodiments, the signal generator comprises an H-bridge circuit. And in some embodiments, the plurality of switches comprise a plurality of triacs.

In some embodiments, the control circuit is configured to receive a user input (e.g., user input 140) to adjust the PWM signal for the first stage of the alternating waveform and/or the second stage of the alternating waveform. In some embodiments, the user input corresponds to one or more of: an adjustment to a time duration of the first stage of the alternating waveform; an adjustment of the first power level of the alternating waveform; and an adjustment of the second power level of the alternating waveform.

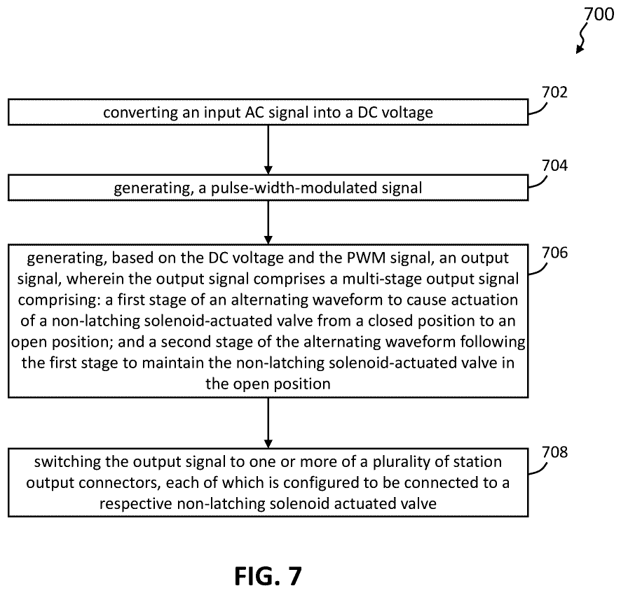

Referring next to FIG. 7, a flow diagram is shown of a method 700 of managing a power output of an irrigation control unit in accordance with some embodiments. It is understood that the steps of the method of FIG. 7 may be performed by one or more of the described irrigation controllers and/or other irrigation controllers not explicitly described herein. The method 700 starts with converting, by an alternating current (AC) to direct current (DC) converter of an irrigation controller, an input AC signal into a direct current (DC) voltage (Step 702). Next, a pulse-width modulation (PWM) signal is generated by a control circuit of the irrigation controller (Step 704). It is noted that in some embodiments, the PWM is generated by retrieving the signal parameters from memory to form the PWM signal. For example, the parameters to generate the PWM signal to provide a given output signal are retrieved from a lookup table in memory, the memory storing different sets of parameters to PWM signaling to create any of the output signals described and variations thereof. Then, an output signal is generated by a signal generator of the irrigation controller and based on the DC voltage and the PWM signal wherein the output signal comprises a multi-stage output signal (Step 706). In some embodiments, the multi-stage output signal comprises a first stage of an alternating waveform having a first power level sufficient to cause actuation of a non-latching solenoid-actuated valve from a closed position to an open position; and a second stage of the alternating waveform following the first stage and having a second power level that is lower than the first power level and is sufficient to maintain the non-latching solenoid-actuated valve in the open position. And the output signal is switched to one or more of a plurality of station output connectors, each of which is configured to be connected to a respective non-latching solenoid actuated valve (Step 708). It is noted that in some embodiments, the step of generating the output signal (Step 706) and the step switching the output signal (Step 708) occur at substantially the same time, while in other embodiments, Step 706 can occur before or after Step 708.

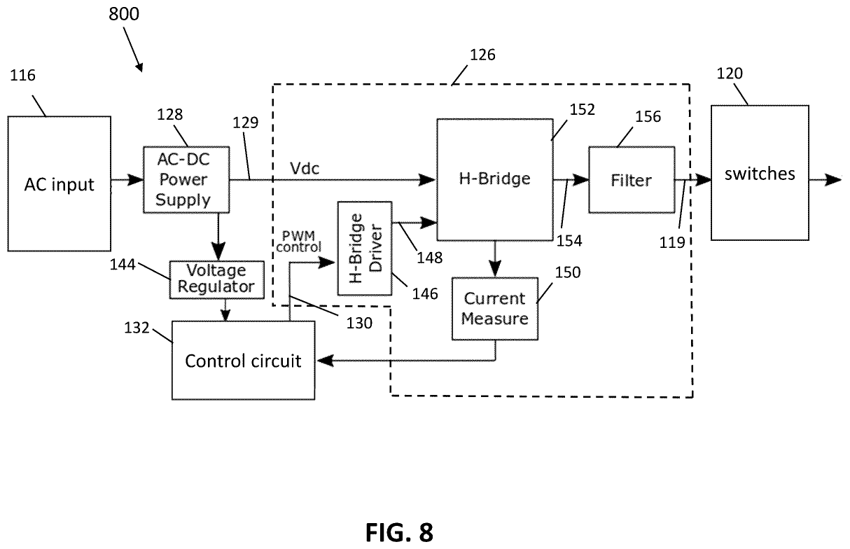

Referring next to FIG. 8, an example signal generator 126 of an irrigation controller 800 using an H-bridge circuit is shown in accordance with some embodiments. In some embodiments, the signal generator 126 may use any switching amplifiers, such as the H-bridge. In some implementations, the signal generator 126 includes an H-Bridge circuit 152, an H-Bridge driver circuit 146, and a filter circuit 156. In some implementations, the signal generator 126 is coupled to the AC to DC power supply (such as the AC to DC converter 128), a voltage regulator 144, and a microcontroller or control circuit, such as the control circuit 132. In some implementations, the signal generator 126 includes a current measure circuit 150. The AC to DC converter 128 provides the DC voltage 129 to the H-Bridge circuit 152. The voltage regulator 144 is coupled to the AC to DC converter 128 and provides operational DC power to the control circuit 132. In some embodiments, the control circuit 132 outputs a Pulse Width Modulation (PWM) signal 130 to the H-Bridge driver circuit 146 which drives the H-Bridge circuit 152 to produce an output signal 119 which is smoothed by the filter circuit 156 to provide the output AC signal 119 for the switches 120 to selectively switch to station output connectors 115 (not shown). In some embodiments, a surge suppressor circuit (not shown) may be provided coupled to the output of the switches 120 to protect the irrigation control system 800 from lightning strikes or other surges on wires, such as the wires 114 connecting the switches 120 to the valves 112. In FIG. 8, the H-Bridge driver circuit 146, the H-Bridge circuit 152, and the filter circuit 156 form one embodiment of the signal generator 126, such as shown in FIGS. 4 and 5.

In some embodiments, the signal generator 126 includes a current measure circuit 150 coupled to the H-Bridge circuit 152 that can sense and measure the current being drawn by valves connected to the switches 120, e.g., in order to detect whether a valve 112 has been opened. The current measure circuit 150 provides an output to the control circuit 132.

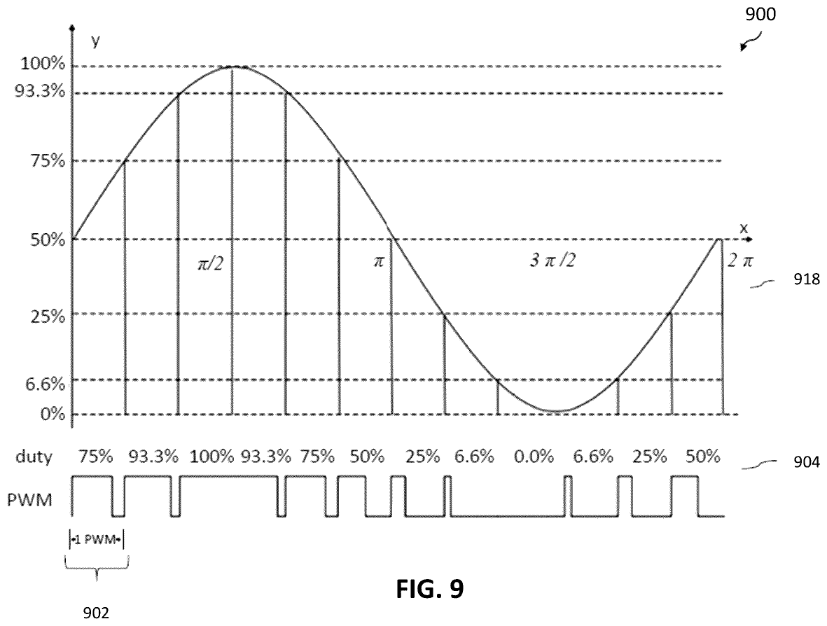

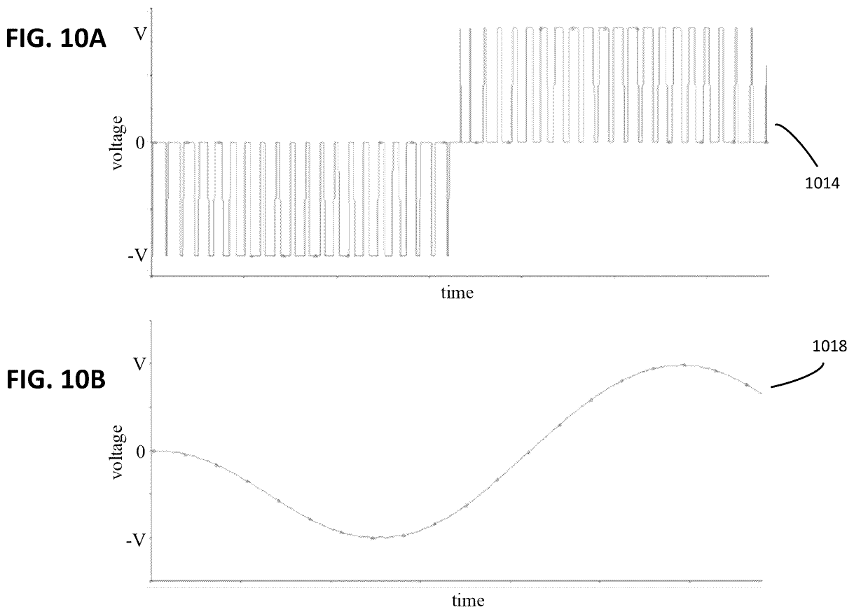

As stated above, the control circuit 132 generates the PWM signal 130 to control the shape of the output signal 119 generated by the H-Bridge circuit 152. It is understood in the art how to generate a PWM signal to drive an H-Bridge circuit to provide an appropriate waveform. In an illustrative non-limiting example, an example PWM signal 904 and corresponding filtered output signal 918 (e.g., a sinusoidal AC voltage waveform) of the system 900 are shown in FIG. 9. The waveform of the output signal is changed by changing the duty and frequency of the PWM signal 904. The PWM signal 904 has cycles, see exemplary PWM cycle 902, each cycle having a pulse of a specified pulse width or duty. The width or duty of the pulses of the PWM signal 904 provides the amplitude of the waveform. The frequency of the PWM signal provides the length of time to complete one cycle 902 of the PWM signal 904. By changing the duty of the PWM signal 904 over a number of cycles 902, the shape of the output signal can be controlled. In the example of FIG. 9, the PWM signal 904 results in a waveform having the form of a sine wave at a given frequency. In some embodiments, to modulate the amplitude of the resulting signal, the duty of the PWM cycles 902 is adjusted, e.g., to create a waveform having a higher or lower amplitude. The duty can be changed cycle by cycle to result in a sinusoidal voltage waveform (such as output signals 119A and 119B), or to result in an alternating square waveform (such as output signal 119C). In some embodiments, to modulate the frequency of the resulting AC signal, the PWM cycles 902 are either shortened at the same duty cycle (shorter time for a higher frequency) or lengthened at the same duty cycle (longer time for lower frequency). In this way, an AC signal can be created at a higher or lower frequency on a sine wave cycle-by-cycle basis. In some embodiments, the characteristics of the PWM signal 904 are changed based on received user input. In some embodiments, the parameters to generate the PWM signal 904 to provide a given output signal are retrieved from a lookup table in memory, the memory storing different sets of parameters to PWM signaling to create any of the output signals described and variations thereof.

In some embodiments, the PWM control signal 904 is input to the H-Bridge driver circuit 146 which provides drive signals 148 to the components of the H-Bridge circuit 152. As such, the H-Bridge output signal 154 is based at least on the drive signals 148 and the DC voltage 129. Thus, the shape, amplitude, frequency and/or phase of the H-Bridge output signal 154 may be selectively modulated each period of the H-Bridge output signal 154 based on the PWM signal 130 output by the control circuit 132. As is known in the art, depending on duty cycle frequency of the PWM signal 130, the resulting AC signal output from the H-Bridge circuit 152 appears as a pulse width modulated waveform showing varying duty cycle. See FIG. 10A, which shows an illustrative non-limiting example of an exemplary H-Bridge output signal 1014 that is a pulse width modulated output waveform. This signal is then filtered to remove unwanted frequencies and smooth the waveform (e.g., using the filter circuit 156), resulting in the AC signal 1018 having a sine wave form. See FIG. 10B which shows an illustrative non-limiting example of the waveform of the resulting output signal 1018 (e.g., one embodiment of the output signal 119).

Alternatively or in addition to, in some embodiments, the H-Bridge output signal 154 passes through the filter circuit 156 to filter unwanted frequencies and smooth the waveform. For example, the filter circuit 156 may include a low pass filter (LPF). In one embodiment, the low pass filter may include one or more inductors L1, L2 and/or capacitors. In an illustrative non-limiting example, exemplary output signals 918 and 1018 are shown in FIGS. 9 and 10B. In some embodiments, the current measure circuit 150 provides a signal to the control circuit 132 that enables the control circuit 132 to determine whether a given valve 112 controlled by the switches 120 is open. In some embodiments, the control circuit 132 is powered by the voltage signal output by the voltage regulator 144. In one embodiment, the voltage regulator 144 regulates the voltage input by the AC to DC converter 128 to ensure that the DC voltage output to the control circuit 132 is the voltage tolerated and/or usable by the control circuit 132.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

1. An irrigation controller comprising:
an alternating current (AC) to direct current (DC) converter configured to convert an input AC signal into a direct current (DC) voltage;
a control circuit coupled to the AC to DC converter and configured to generate a pulse-width modulation (PWM) signal;
a signal generator coupled to the AC to DC converter and to the control circuit, wherein the signal generator is configured to generate, based on the DC voltage and the PWM signal, an output signal, wherein the output signal comprises a multi-stage output signal comprising:
a first stage of an alternating waveform having a first power level sufficient to cause actuation of a non-latching solenoid-actuated valve from a closed position to an open position; and
a second stage of the alternating waveform following the first stage and having a second power level that is lower than the first power level and is sufficient to maintain the non-latching solenoid-actuated valve in the open position; and
a plurality of switches each coupled to the signal generator, wherein the control circuit is configured to selectively control operation of the plurality of switches to switch the output signal to one or more of a plurality of station output connectors, each of which is configured to be connected to a respective non-latching solenoid actuated valve.

2. The irrigation controller of claim 1, wherein the PWM signal causes the signal generator to generate the output signal such that the first stage of the alternating waveform comprises a first sinusoidal AC voltage signal having a first amplitude and the second stage of the alternating waveform comprises a second sinusoidal AC voltage signal having a second amplitude, the second amplitude lower than the first amplitude.

3. The irrigation controller of claim 1, wherein the PWM signal causes the signal generator to generate the output signal such that the first stage of the alternating waveform comprises a first alternating square wave voltage signal having the first amplitude and the second stage of the alternating waveform comprises a second sinusoidal AC voltage signal having a second amplitude, the second amplitude lower than the first amplitude.

4. The irrigation controller of claim 1, wherein each station output connector is coupled by a wireline to the respective non-latching solenoid-actuated valve.

5. The irrigation controller of claim 1, wherein the control circuit is further configured to modify, through variation of the PWM signal, an amplitude of the output signal.

6. The irrigation controller of claim 1, wherein the AC to DC converter is directly coupled to the input AC signal without first passing through an AC transformer.

7. The irrigation controller of claim 1, wherein a time duration of the first stage of the alternating waveform corresponds to 4 to 10 cycles of the output power signal.

8. The irrigation controller of claim 7, wherein a time duration of the second stage of the alternating waveform corresponds to a remainder of a scheduled irrigation run time.

9. The irrigation controller of claim 1, wherein the AC to DC converter outputs a DC voltage of between about 24 and 28 volts.

10. The irrigation controller of claim 1, wherein the AC to DC converter outputs a DC voltage of between about 34 and 48 volts.

11. The irrigation controller of claim 1, wherein the control circuit is configured to change the PWM signal for the signal generator to transition from the first stage of the alternating waveform to the second stage of the alternating waveform.

12. The irrigation controller of claim 1, wherein the control circuit is configured to receive a user input to adjust the PWM signal for the first stage of the alternating waveform and/or the second stage of the alternating waveform.

13. The irrigation controller of claim 12, wherein the user input corresponds to one or more of:
an adjustment to a time duration of the first stage of the alternating waveform;
an adjustment of the first power level of the alternating waveform; and
an adjustment of the second power level of the alternating waveform.

14. A method of managing power in an irrigation system comprising:
converting, by an alternating current (AC) to direct current (DC) converter of an irrigation controller, an input AC signal into a direct current (DC) voltage;
generating, by a control circuit of the irrigation controller, a pulse-width modulation (PWM) signal;
generating, by a signal generator of the irrigation controller and based on the DC voltage and the PWM signal, an output signal, wherein the output signal comprises a multi-stage output signal comprising:
a first stage of an alternating waveform having a first power level sufficient to cause actuation of a non-latching solenoid-actuated valve from a closed position to an open position; and
a second stage of the alternating waveform following the first stage and having a second power level that is lower than the first power level and is sufficient to maintain the non-latching solenoid-actuated valve in the open position; and
switching the output signal to one or more of a plurality of station output connectors, each of which is configured to be connected to a respective non-latching solenoid actuated valve.

15. The method of claim 14, wherein the generating the output signal step comprises generating the output signal such that the first stage of the alternating waveform comprises a first sinusoidal AC voltage signal having a first amplitude and the second stage of the alternating waveform comprises a second sinusoidal AC voltage signal having a second amplitude, the second amplitude lower than the first amplitude.

16. The method of claim 14, wherein the generating the output signal step comprises generating the output signal such that the first stage of the alternating waveform comprises a first alternating square wave voltage signal having the first amplitude and the second stage of the alternating waveform comprises a second sinusoidal AC voltage signal having a second amplitude, the second amplitude lower than the first amplitude.

17. The method of claim 14, wherein each station output connector is coupled by a wireline to the respective non-latching solenoid-actuated valve.

18. The method of claim 14, further comprising modifying, by the control circuit and through variation of the PWM signal, an amplitude of the output signal.

19. The method of claim 14, wherein prior to the converting step, the input AC signal is not passed through an AC transformer.

20. The method of claim 14, wherein the generating the output signal step comprises generating the output signal such that a time duration of the first stage of the alternating waveform corresponds to 4 to 10 cycles of the output power signal.

21. The method of claim 20, wherein the generating the output signal step comprises generating the output signal such that a time duration of the second stage of the alternating waveform corresponds to a remainder of a scheduled irrigation run time.

22. The method of claim 14, wherein the converting step comprises converting the input AC signal into the DC voltage having a value between about 24 and 28 volts.

23. The method of claim 14, wherein the converting step comprises converting the input AC signal into the DC voltage having a value between about 34 and 48 volts.

24. The method of claim 14, further comprising changing, by the control circuit, the PWM signal to transition from the first stage of the alternating waveform to the second stage of the alternating waveform.

25. The method of claim 14, further comprising receiving a user input to adjust the PWM signal for the first stage of the alternating waveform and/or the second stage of the alternating waveform.

26. The method of claim 25, wherein the user input corresponds to one or more of:
an adjustment to a time duration of the first stage of the alternating waveform;
an adjustment of the first power level of the alternating waveform; and
an adjustment of the second power level of the alternating waveform.
